(19) United States
(12) Patent Application Publication
(10) Pub. No.: US 2013/0032268 A1
(43) Pub. Date: Feb. 7, 2013

(54) TIRE HAVING KNIT FABRIC IN SIDEWALL AREA

(71) Applicants: Dominique Cinget, Combles (FR); Purushothama Kini Ullal, Singapore (SG); Johann Peschek, Gent (BE); Franck Catteau, Marquette lez Lille (FR)

(72) Inventors: Dominique Cinget, Combles (FR); Purushothama Kini Ullal, Singapore (SG); Johann Peschek, Gent (BE); Franck Catteau, Marquette lez Lille (FR)

(21) Appl. No.: 13/195,961

(22) Filed: Aug. 2, 2011

(51) Int. Cl. B60C 13/00; B29D 30/08; B60C 15/06

(52) U.S. Cl. 152/542; 152/450; 152/543; 156/83

(57) ABSTRACT

A tire containing a pair of beads, at least one carcass ply extending from one bead to the other bead forming a pair of sidewall areas of the tire and a tread area of the tire, and at least one layer of a knit fabric in the sidewall area of the tire.

### TECHNICAL FIELD

The present disclosure relates generally to knit fabrics for use in tires and in particular to the construction of ply tires with a knit fabric in the sidewall area of the tire.

### BACKGROUND

Some vehicles, such as trucks, large equipment, and high performance cars, have a need for tires having additional reinforcement in the sidewall area. There is a need for fabrics that have enough elongation to allow for stretching during the lift up of the tire during manufacturing and provide excellent reinforcement.

### BRIEF SUMMARY

A tire containing a pair of beads, at least one carcass ply extending from one bead to the other bead forming a pair of sidewall areas of the tire and a tread area of the tire, and at least one layer of a knit fabric in the sidewall area of the tire. A method of making the fabric and tire are also disclosed.

### BRIEF DESCRIPTION OF THE FIGURES

An embodiment of the present invention will now be described by way of example, with reference to the accompanying drawings.

FIG. 1 is a cutaway partial view of a pneumatic radial tire.

FIGS. 2 and 3 are micrographs of one embodiment of an atlas knit fabric. FIG. 3 is at a higher magnification than FIG. 2.

FIG. 4A depicts the yarn patterns for one embodiment of the knit fabric being an atlas knit fabric. FIG. 4B is chain notation for lapping diagram of FIG. 4A.

FIG. 5A depicts the yarn patterns for another embodiment of the knit fabric being an atlas knit fabric. FIG. 5B is chain notation for lapping diagram of FIG. 5A.

FIG. 6A depicts the yarn patterns for another embodiment of the knit fabric being an atlas knit fabric. FIG. 6B is chain notation for lapping diagram of FIG. 6A.

FIGS. 7-18 depict alternative yarn patterns for use in a knit fabric.

FIGS. 19A and 19B depict the yarn patterns for additional embodiments of the knit fabric having an additional set of warp yarns in a chain stitch.

FIG. 20 depicts the yarn patterns for one embodiment of the knit fabric having a laid-in weft yarn.

FIG. 21 depicts the yarn patterns for one embodiment of the knit fabric having a laid-in warp yarn.

FIG. 22 is a schematic of a top view of a pattern coated knit fabric having tackifing layer on surface of the fabric over the adhesion layer in a discontinuous dot pattern.

FIG. 23 is a schematic of a top view of a pattern coated knit fabric having tackifing layer on surface of the fabric over the adhesion layer in a discontinuous pattern of random areas.

FIG. 24 is a schematic of a top view of a pattern coated knit fabric having tackifing layer on surface of the fabric over the adhesion layer in a grid pattern.

FIG. 25 is a schematic of a top view of a pattern coated knit fabric having tackifing layer on surface of the fabric over the adhesion layer in a pattern of a series of parallel lines.

FIGS. 26A and 26B are schematics of side views of knit fabrics showing the tackifing layer having a discontinuous pattern on surface of the fabric over the adhesion layer.

FIG. 27 is a schematic of a side view of a knit fabric showing the tackifing layer having a discontinuous pattern on surface of the fabric over the adhesion layer, where the coated knit fabric is embedded into rubber.

FIG. 28 is a schematic of a top view of a pattern coated knit fabric having tackifing layer on surface of the fabric over the adhesion layer in a pattern of dots of varying density across the fabric.

### DETAILED DESCRIPTION

“Apex” means a reinforced or non-reinforced elastomer positioned radially above a bead core.

“Axial” and “axially” mean lines or directions which are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Cut belt or cut breaker reinforcing structure” means at least two cut layers of plies of parallel cords, underlying the tread, unanchored to the bead, and having both left and right cord angles in the range from 10 degrees to 45 degrees with respect to the equatorial plane of the tire.

“Bias-ply tire” means a tire having a carcass with reinforcing cords in the carcass ply extending diagonally across the tire from bead core to bead core at about a 25°-50° angle with respect to the equatorial plane of the tire. Cords run at opposite angles in alternate layers.

“Cap ply” means a reinforcement structure, typically a woven or knit fabric, located under the tread portion of the tire.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chipper” refers to a narrow band of fabric or steel cords located in the bead area whose function is to reinforce the bead area and stabilize the radially inward most part of the sidewall.

“Cord” means one of the reinforcement strands of which the plies in the tire are comprised.

“Flipper” means a reinforced fabric wrapped about the bead core and apex.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Turn-up end” means the portion of a carcass ply that turns upward (i.e., radially outward) from the beads about which the ply is wrapped.

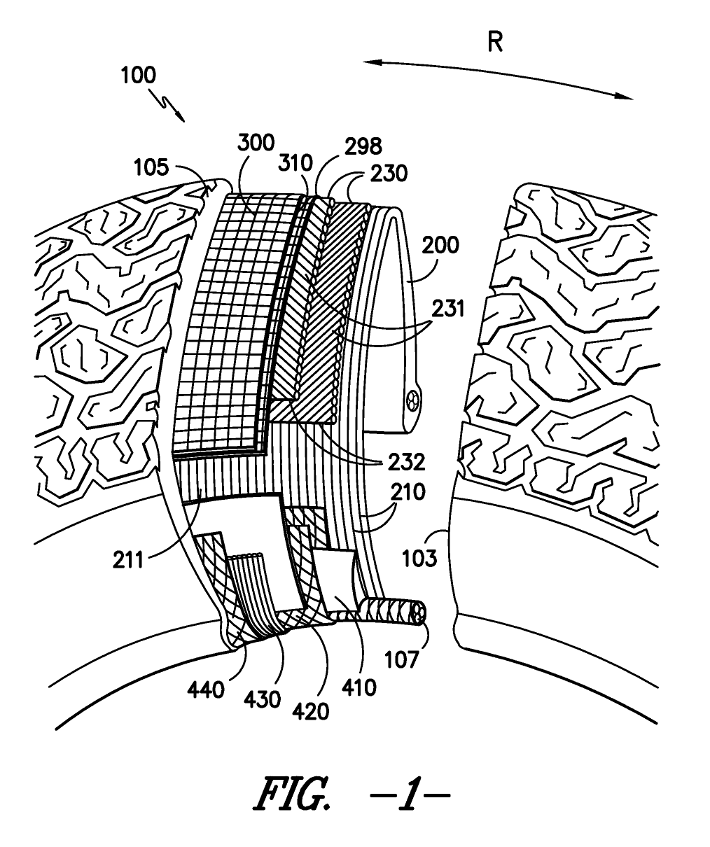

Referring now to FIG. 1, there is shown a tire 100, comprising sidewalls 103 extending from the bead 107 to the tread 105. The tire 100 includes a carcass 200 covered by the tread 105. In FIG. 1, the tire 100 is a radial tire; however, the present invention is not limited to radial tires and can also be used with other tire constructions. The carcass 200 is formed from one or more plies of tire cord 210 terminating at the inner periphery of the tire in metal beads 107, with at least one breaker 230 located circumferentially around the tire cord 210 in the area of the tread 105. In the tire shown in FIG. 1, the carcass 200 is constructed so that the reinforcing cords 210 are running substantially radially of the intended direction of rotation R of the tire 100. The breakers 230 are formed with relatively inextensible warp materials 231, such as steel cord reinforcing warps, which run in the intended direction of rotation R of the tire or, more usually, at a slight angle thereto. The angle of the inextensible warp materials 231 can vary with the method of construction or application. The breakers 230 extend across the width of the tread 105 of the tire terminating in edges 232 in the area of the tire 100 where the tread 105 meets the sidewall 103.In some tire constructions, a cap ply layer 300 is located between the breakers 230 and the tread 105.

On top of the bead 107 is the bead apex 410 and surrounding at least partially the bead 107 and the apex 410 is a flipper 420. The flipper 420 is a fabric layer disposed around the bead 107 and inward of the portion of the turn-up end 430. A chipper 440 is disposed adjacent to the portion of the ply 430 that is wrapped around the bead 107. More specifically, the chipper 440 is disposed on the opposite side of the portion of the ply the “turn-up end” 430 from the flipper 420. The sidewall may also contain other non-shown fabric layers, for example chafer fabrics, toe protector fabrics, or fabrics wrapping around the bead, extending from the bead up the side of the sidewall, extending from the tread down the sidewall, in the shoulder area, or completely covering the sidewall. Any fabric extending between the bead and the tread is defined herein as a “sidewall fabric”. This includes fabrics that also extend around the bead to the inside of the tire such as a flipper fabric, as long as at least part of the fabric is located between the bead and the tread.

Tires are typically constructed on mandrels and then are blown-up and expanded to form the three-dimensional tire shape. The sidewall fabrics must be able to stretch to accommodate this expansion and shaping. Typically bias fabrics are used as they can adapt to some level of stretching.

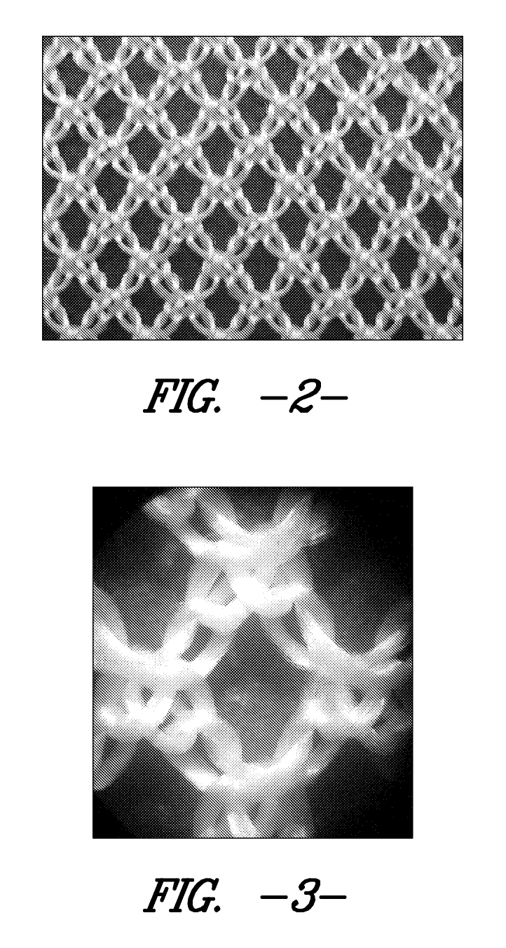

The sidewall fabric is a knit fabric. Preferably, the knit fabric is a type of net knit fabric having stretch-ability in more than one direction. Most preferably, the knit fabric is an atlas fabric. It has been shown that the atlas knit fabric provides good stretch-ability in more than one direction making it well suited to goods that undergo an expansion during manufacture, such as a tire. FIGS. 2 and 3 show images of one embodiment of the atlas knit fabric. FIG. 3 was taken at a high magnification than FIG. 2. The knitted pattern has multiple patterns of diagonally shifting yarns. Such a pattern forms a “net” and provides stretch-ability to the fabric 500.

The sidewall area of the tire comprises at least one layer of knit fabric, preferably an atlas knit fabric. In another embodiment, the sidewall area of the tire comprises at least two layers of knit fabrics. The knit fabrics may overlap each other or be placed in discrete sections of the sidewall. In one embodiment, a chafer may comprise two layers of the knit fabric for added protection. In another embodiment, the knit fabric may be used for both the clipper and the flipper. In the embodiments where there is more than one layer of knit fabric in the sidewall area, preferably at least one of the layers is an atlas knit fabric.

The knit fabric may knit in any suitable manner and pattern, preferably an atlas knit pattern. Knitting involves the interlooping or stitching of yarn into vertical columns (wales) and horizontal rows (courses) of loops to form the knitted fabric structure. In warp knitting, the loops are formed along the textile length, i.e., in the wale or warp direction of the textile. For a tubular textile, such as circular knit fabric, stitches extending in the axial or longitudinal direction of the tubular textile are called courses and stitches extending along the circumference of the tubular textile are called wales. Preferably, the knit fabric is knitted forming a net fabric.

The knit fabric may contain open loops and/or closed loops. As used herein, open loops refer to interlacing yarns where a front or a back yarn does not cross over itself in forming the loop. Also, as used herein, closed loops refer to interlacing yarns where a front or a back yarn crosses over itself in forming the loop. In one embodiment, the knit fabric is an open loop construction meaning that the stitches between the turning stitches are open. This construction is sometimes preferred as it may produce the lightest weight and most open knit fabric. In another embodiment, the knit fabric is a closed loop construction meaning that the stitches between the turning stitches are closed. In one embodiment, the turning stitches (first and second) of the knit fabric are closed. In another embodiment, the turning stitches (first and second) of the knit fabric are open. In another embodiment, the turning stitches in the knit fabric may be a mixture of open and closed. In one embodiment in the knit fabric, the movement between stitches is an underlap movement, and in other embodiments, the movement between stitches is an overlap movement.

The knit fabric contains at least a first set of warp yarns and a second set of warp yarns. The first set of warp yarns has a repeating pattern comprising (the brackets are added to more clearly show the part of the pattern set that may be repeated more than once):

a first turning stitch,

a stitch shift traversing diagonally at least one wale per at least one course in a first direction,

at least one set of [a stitch and a stitch shift traversing diagonally at least one wale per at least one course] in the first direction,

a second turning stitch,

a stitch shift traversing diagonally at least one wale per at least one course in a second direction opposite to the first direction, and

at least one set of [a stitch and a stitch shift traversing diagonally at least one wale per at least one course] in the second direction.

The second set of warp yarns has a repeating pattern comprising:
a first turning stitch,
a stitch shift traversing diagonally at least one wale per at least one course in the second direction,
at least one set of [a stitch and a stitch shift traversing diagonally at least one wale per at least one course] in the second direction,
a second turning stitch,
a stitch shift traversing diagonally at least one wale per at least one course in the first direction, and
at least one set of [a stitch and a stitch shift traversing diagonally at least one wale per at least one course] in the first direction.

The warp yarns of the knit fabric may be any suitable yarn, including but not limited to a spun staple yarn, a multifilament yarn, and/or a monofilament yarn and are formed of a material which will restrain the belt plies 230. “Yarn”, in this application, as used herein includes a monofilament elongated body, a multifilament elongated body, ribbon, strip, fiber, tape, and the like. The term yarn includes a plurality of any one or combination of the above. Some suitable materials for the yarns include polyamide, aramids (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic or any other suitable artificial or natural fiber. In one embodiment, the yarns are preferably rayon, polyester or nylon.

In one embodiment, the yarns may be single monofilament or multifilaments yarns (twisted and/or cabled cords) made with any of the prior listed materials, also including hybrid yarns, or film-tape yarns. In one embodiment for some tire fabrics, the warp yarns may be between 100 decitex (90 deniers) up to 3,000 decitex made with single or multiple yarns (for example, 235 decitex (single end) or 235 decitex×2×3 plies equals 1,410 decitex or 1,100 decitex×3×3 plies equal to 9,900 decitex (multiple ends)). The yarns may be flat, textured and/or twisted.

In one embodiment, the warp yarns may be hybrid yarns. These hybrid yarns are made up of at least 2 fibers of different fiber material (for example, cotton and nylon). These different fiber materials can produce hybrid yarns with different chemical and physical properties. Hybrid yarns are able to change the physical properties of the final product they are used in. Some preferred hybrid yarns include an aramid fiber with a nylon fiber, an aramid fiber with a rayon fiber, and an aramid fiber with a polyester fiber.

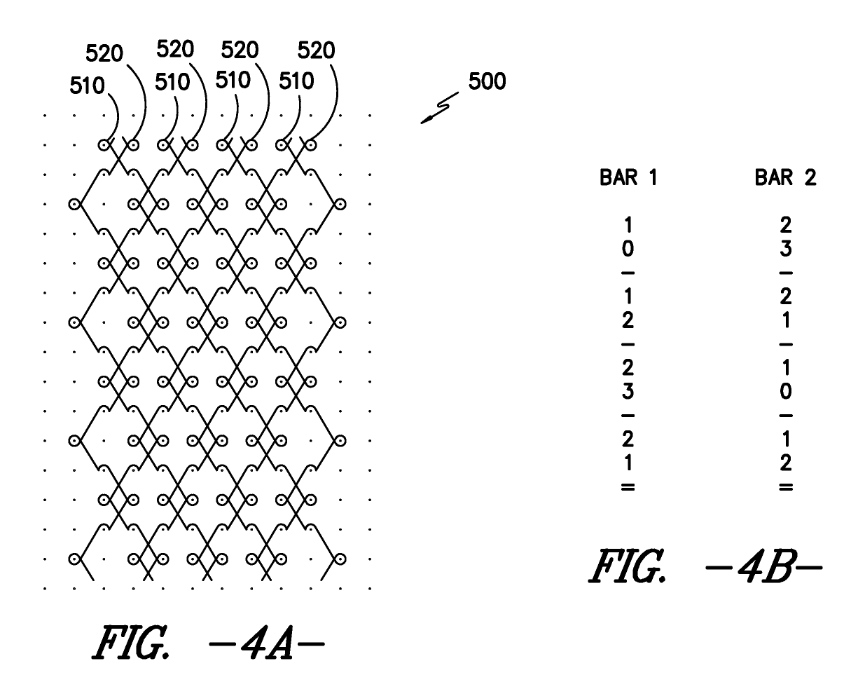

Referring now to FIG. 4A, there is shown a stitching diagram of one embodiment of the knit fabric 500. The knit fabric 500 (in this embodiment as atlas knit) has a warp direction 500a and a weft direction 500b, a first set of warp yarns 510 and a second set of warp yarns 520. In the knit shown in FIG. 4A, the process of knitting each warp yarn 510, 520 advances several times in succession in the same direction and then comes back in the opposite direction. In one embodiment, each of the first turning stitches of the first set of warp yarns 510 are on the same wale. In another embodiment, each of the second turning stitches of the first set of warp yarns 510 are on the same wale. In one embodiment, each of the first turning stitches of the second set of warp yarns 520 are on the same wale. In another embodiment, each of the second turning stitches of the second set of warp yarns 520 are on the same wale. In another embodiment, the first turning stitches of the first warp set and the first turning stitches of the second warp yarn set are on the same course. FIG. 4B is chain notation for lapping diagram of FIG. 4A.

The first set of warp yarns 510 of the atlas knit fabric of FIG. 4A contain the following pattern:
a first closed loop turning stitch,
a stitch shift traversing diagonally one wale and one course in a first direction,
an open loop stitch,
a stitch shift traversing diagonally one wale per one course in the first direction,
a second closed loop turning stitch,
a stitch shift traversing diagonally one wale per one course in a second direction opposite to the first direction,
an open loop stitch, and
a stitch shift traversing diagonally one wale per one course in the second direction.

The second set of warp yarns 520 of the atlas knit fabric of FIG. 4A contain the following pattern:
a first closed loop turning stitch,
a stitch shift traversing diagonally one wale and one course in the second direction,
an open loop stitch,
a stitch shift traversing diagonally one wale per one course in the second direction,
a second closed loop turning stitch,
a stitch shift traversing diagonally one wale per one course in the first direction,
an open loop stitch, and
a stitch shift traversing diagonally one wale per one course in the first direction.

In the fabric shown in the lapping diagram of FIG. 4A, the second set of warp yarns 520 have the same stitch pattern as the first set of warp yarns 510, except the first direction and second direction of the stitch shifts are reversed causing the second set of warp yarns 520 to be a mirror image to the first set (and is also offset one wale from the first set of warp yarns 510). This atlas knit in which two neighboring yarns forming the knitted fabric advance in the same manner but are inverted is sometimes referred to as a reverse atlas knit. This reverse atlas knit pattern shown in FIG. 4A corresponds to the actual fabric in the micrographs of FIGS. 2 and 3.

For the embodiments of the knit fabric 500 having a first set of warp yarns 510 and a second set of warp yarns 520, the turning stitches may be aligned or not aligned on the same wale. In one embodiment, each of the first turning stitches of the first set of warp yarns 510 are on the same wale. In another embodiment, each of the second turning stitches of the first set of warp yarns 510 are on the same wale. In one embodiment, each of the first turning stitches of the second set of warp yarns 520 are on the same wale. In another embodiment, each of the second turning stitches of the second set of warp yarns 520 are on the same wale. In one embodiment, each of the first turning stitches of the first set of warp yarns 510 and the second set of warp yarns 520 are on the same wale. In another embodiment, each of the second turning stitches of the first set of warp yarns 510 and the second set of warp yarns 520 are on the same wale.

FIGS. 5A and 5B illustrate another embodiment of a possible atlas knit fabric 500. FIG. 5B is chain notation for lapping diagram of FIG. 5A.

The first set of warp yarns 510 of the atlas knit fabric of FIG. 5A contain the following pattern:
a first closed loop turning stitch,
a stitch shift traversing diagonally two wales and one course in a first direction,
an open loop stitch,
a stitch shift traversing diagonally two wales per one course in the first direction,
a second closed loop turning stitch,
a stitch shift traversing diagonally two wales per one course in a second direction opposite to the first direction,
an open loop stitch, and
a stitch shift traversing diagonally two wales per one course in the second direction.

The second set of warp yarns 520 of the atlas knit fabric of FIG. 5A contain the following pattern:
a first closed loop turning stitch,
a stitch shift traversing diagonally two wales and one course in the second direction,
an open loop stitch,
a stitch shift traversing diagonally two wales per one course in the second direction,
a second closed loop turning stitch,
a stitch shift traversing diagonally two wales per one course in the first direction,
an open loop stitch, and
a stitch shift traversing diagonally two wales per one course in the first direction.

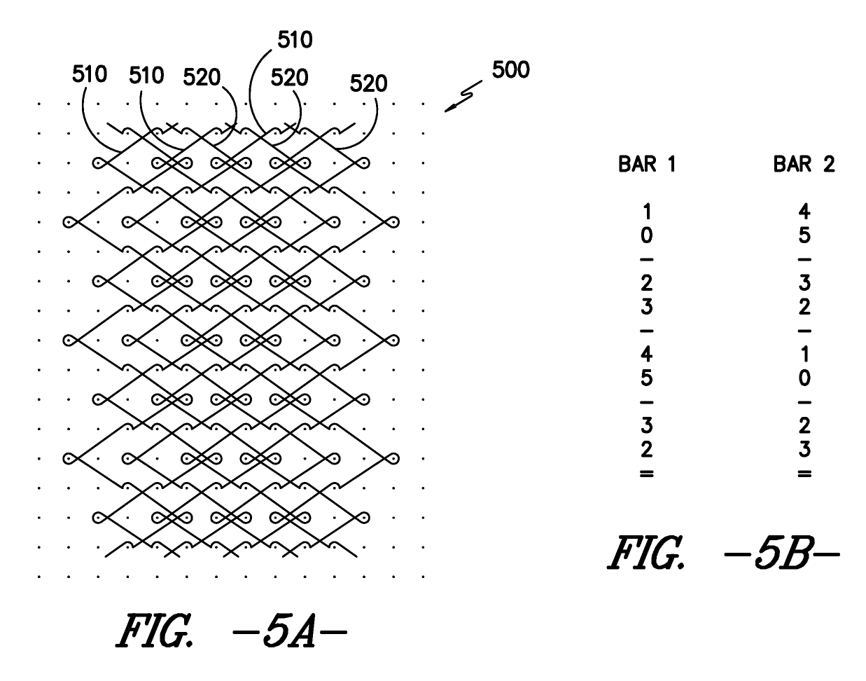

FIGS. 6A and 6B illustrate another embodiment of a possible atlas knit fabric 500. FIG. 6B is chain notation for lapping diagram of FIG. 6A.

The first set of warp yarns 510 of the atlas knit fabric of FIG. 6A contain the following pattern:
a first closed loop turning stitch,
a stitch shift traversing diagonally one wale and one course in a first direction,
an open loop stitch,
a stitch shift traversing diagonally one wale per one course in the first direction,
a second open loop stitch,
a stitch shift traversing diagonally one wale per one course in the first direction,
a second closed loop turning stitch,
a stitch shift traversing diagonally one wale per one course in a second direction opposite to the first direction,
an open loop stitch,
a stitch shift traversing diagonally one wale per one course in the second direction,
a second open loop stitch,
a stitch shift traversing diagonally one wale per one course in the second direction.

The second set of warp yarns 520 of the atlas knit fabric of FIG. 6A contain the following pattern:
a first closed loop turning stitch,
a stitch shift traversing diagonally one wale and one course in the second direction,
an open loop stitch,
a stitch shift traversing diagonally one wale per one course in the second direction,
a second open loop stitch,
a stitch shift traversing diagonally one wale per one course in the second direction,
a second closed loop turning stitch,
a stitch shift traversing diagonally one wale per one course in the first direction,
an open loop stitch,
a stitch shift traversing diagonally one wale per one course in the first direction,
a second open loop stitch, and
a stitch shift traversing diagonally one wale per one course in the first direction.

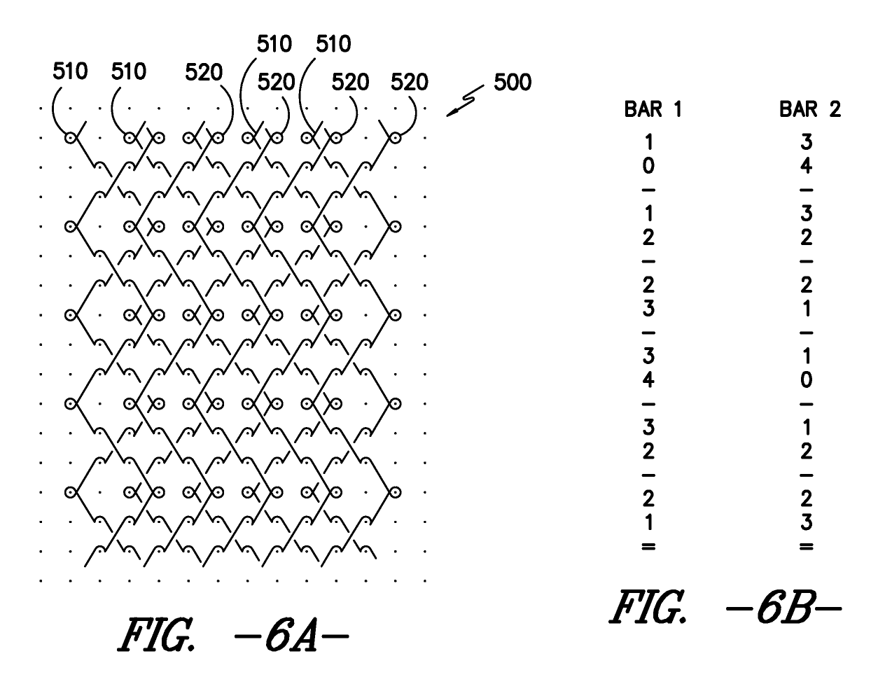

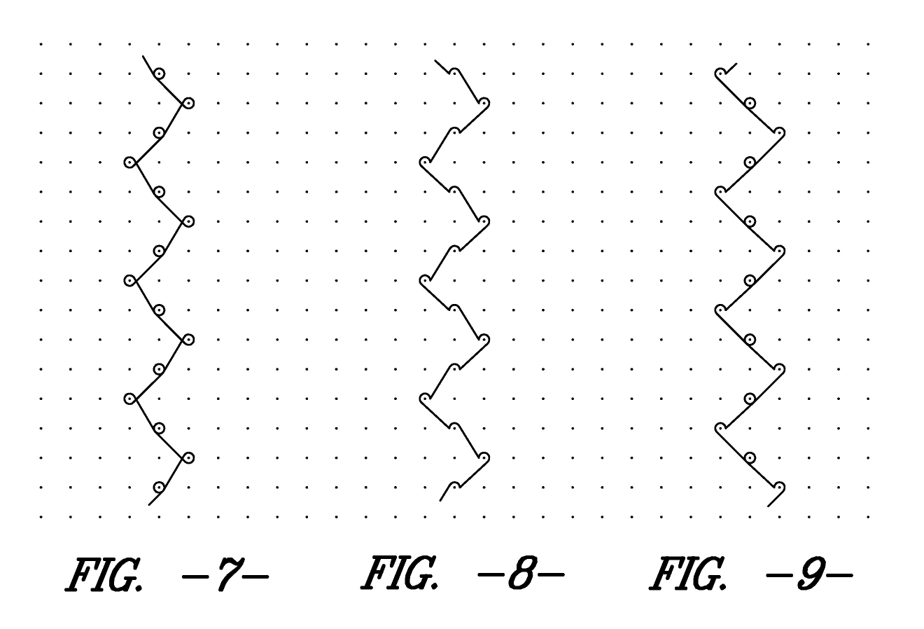

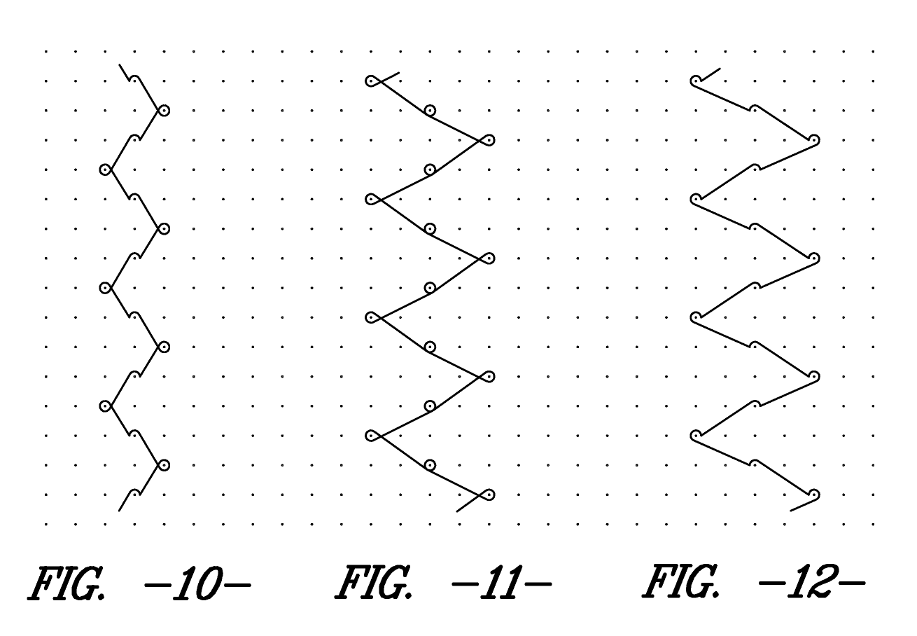

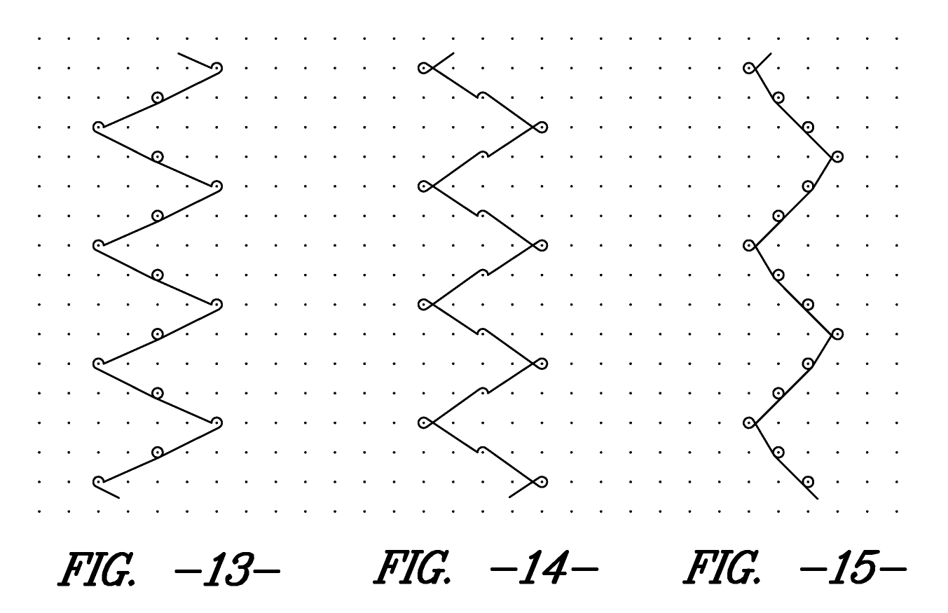

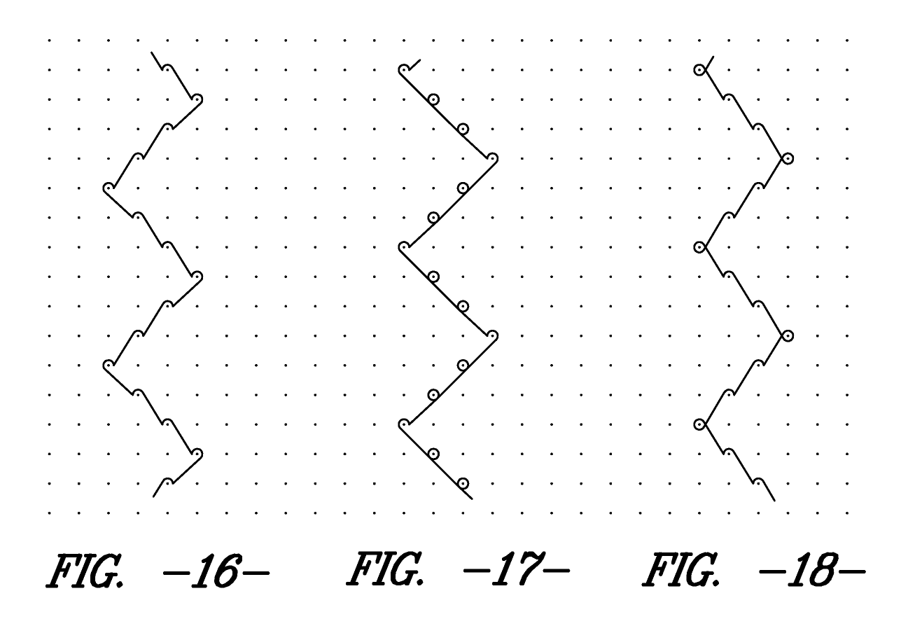

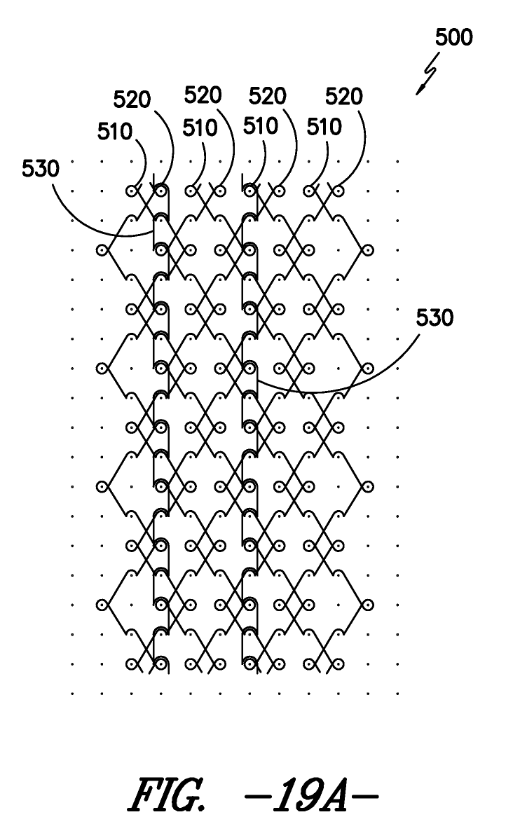

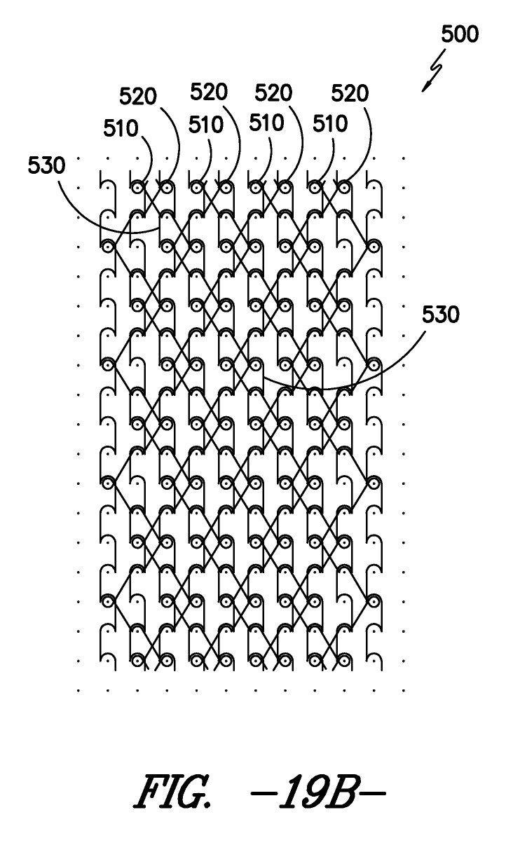

FIGS. 7-18 illustrate alternative repeating patterns for use in the knit fabric. The patterns shown may be used in simple, reverse, or a modified atlas stitch for the first set of warp yarns and/or the second set of warp yarns. FIGS. 7-18 are just examples, any other suitable repeating pattern may be used. FIGS. 7-18 show an assortment of stitch patterns with open turning stitches, closed turning stitches, open loop stitches, closed loop stitches, patterns extending 3 rows, patterns extending 4 rows, etc.

While all of the knit patterns shown are symmetrical in FIG. 7-18, meaning that the patterns are mirror images around the turning stitches, the repeating pattern may contain, for example, a stitch shift traversing diagonally two wales per one course, an loop stitch, a stitch shift traversing diagonally one wale per one course, a turning stitch, a stitch shift traversing diagonally two wales per one course, an loop stitch, and a stitch shift traversing diagonally one wale per one course. In another embodiment, the repeating pattern for the first warp yarns 510 is different than the second warp yarns 520.

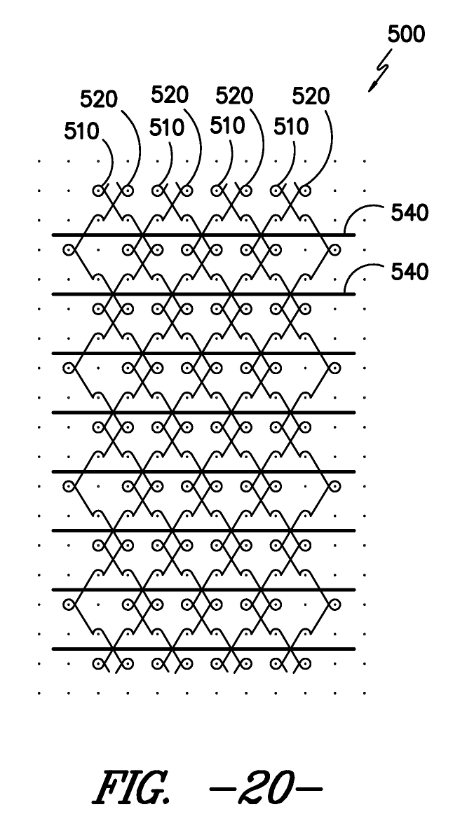

In another embodiment as shown in FIG. 19A, the knit fabric 500 contains a first set of warp yarns 510 in an atlas stitch pattern, a second set of warp yarns 520 in an atlas stitch pattern, and a third set of warp yarns 530 in a chain stitch pattern (sometimes also referred to as a pillar stitch). This chain stitch may be formed from the same materials as the first and/or second warp yarn set or may be a very weak, or thin yarn. One purpose for the chain stitch would be for easier handling and subsequent coating of the knit fabric as the openness of the knit fabric may lead to handling and conveyance difficulties. In FIG. 19A, the chain stich is on every third wale. The chain stitches 530 may also be on every wale, such as shown in FIG. 19B, or on any suitable repeating pattern (such as every second, third, fourth, fifth, etc.) In one embodiment, the frequency of the chain stitches on the wales varies across the fabric (for example, one section of the fabric may have chain stitches on every wale, another section may have chain stitches on every fifth wale, and between the two sections may be a frequency gradient or a step change).

In one embodiment, the knit fabric 500 contains stabilizing yarns in the weft and/or warp direction. The stabilizing yarns provide stability to the fabric during formation and subsequent processes and limit the stretch of the fabric in the direction of the stabilizing yarns. If the stabilizing yarns are in the weft direction, the fabric will have unidirectional elongation in the warp direction. If the stabilizing yarns are in the warp direction, the fabric with have unidirectional elongation in the weft direction. Generally, the stabilizing yarns in the weft and warp directions would be disposed substantially regularly. However, increase, or reduction, can be envisaged of the number of reinforcing yarns at certain places in the fabric, notably depending on the destination and end use of the fabric. The stabilizing yarns may be added to any of the embodiments of the knit including the atlas knit.

The stabilizing yarns may be made of any suitable material including any yarn suitable for use as a warp yarn in the knit fabric. Some suitable materials for the yarns include polyamide, aramids (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, hybrid yarns, polyacrylic or any other suitable artificial or natural fiber. In one embodiment, the stabilizing yarns are preferably rayon, aramid, or nylon. The nylon may be monofilament or multifilament.

FIG. 20 shows one embodiment where stabilizing weft yarns 540 are inserted into the knit fabric 500 between the rows of stitches. The laid-in weft insertion yarns 540 are held in place in the knit fabric 500 by the casts of the warp yarns 510, 520 without participating in the formation of the stitches. As a variant, it includes several, for example two or three, stabilizing yarns in the weft direction between each row of stitches. Though the weft yarns 540 are inserted in every other course in FIG. 20, any suitable insertion pattern may be used such as being disposed one row of stitches out of two, three, four or more.

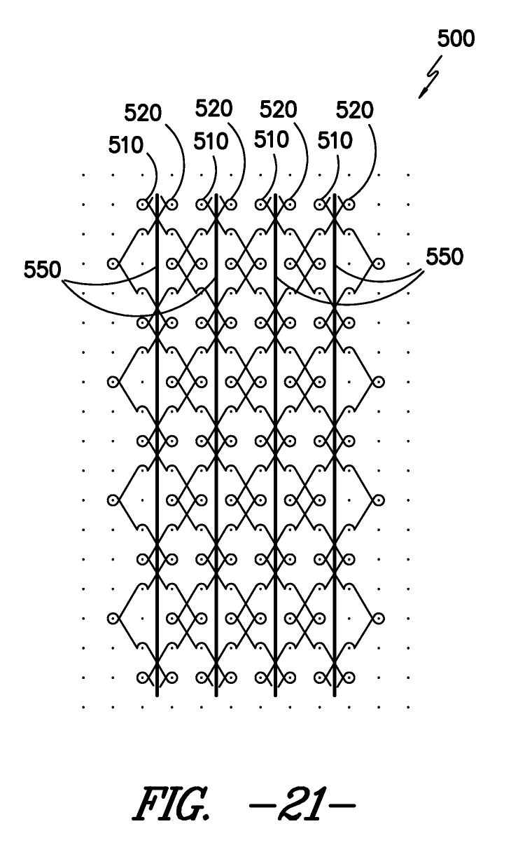

FIG. 21 shows another embodiment where stabilizing warp yarns 550 are inserted into the knit fabric 500. The laid-in warp insertion yarns 550 in the warp direction are laid-in, meaning that they are disposed between each column of stitches or, as a variant, one column of stitches out of two, three, four or more. Provision can also be envisaged of several, for example two or three, stabilizing yarns 550 between each column of stitches or one column of stitches out of two, three, four or more.

A frequent problem in making a rubber composite is maintaining good adhesion between the rubber and the reinforcement fabric. A conventional method in promoting the adhesion between the rubber and the reinforcement fabric is to pretreat the reinforcing yarns with an adhesion layer typically formed from a mixture of rubber latex and a phenol-formaldehyde condensation product wherein the phenol is almost always resorcinol. This is the so called “RFL” (resorcinol-formaldehyde-latex) method. The resorcinol-formaldehyde latex can contain vinyl pyridine latexes, styrene butadiene latexes, waxes, fillers and/or other additives. “Adhesion layer” used herein includes RFL chemistries and other non-RFL rubber adhesive chemistries.

In one embodiment, the adhesion chemistries are not RFL chemistries. In one embodiment, the adhesion chemistries do not contain formaldehyde. In one embodiment the adhesion composition comprises a non-cross-linked resorcinol-formaldehyde and/or resorcinol-furfural condensate (or a phenol-formaldehyde condensate that is soluble in water), a rubber latex, and an aldehyde component such as 2-furfuraldehyde. The composition may be applied to textile substrates and used for improving the adhesion between the treated textile substrates and rubber materials. More information about these chemistries may be found in U.S. application Ser. No. 13/029,293 filed on Feb. 17, 2011, which is incorporated herein in its entirety.

The knit fabric 500 is coated with adhesive layer by a conventional method. Preferably, the adhesion layer is a resorcinol formaldehyde latex (RFL) layer or rubber adhesive layer. Generally, the adhesion layer is applied by dipping the knit fabric or yarns (before formation into knit fabric) in the adhesion layer solution. The coated fabric or yarns then pass through squeeze rolls and a drier to remove excess liquid. The adhesion layer is typically cured at a temperature in the range of 150° to 200° C. The adhesion layer is typically on both sides of the knit fabric and preferably coats all or almost all available surface of the yarns within the knit fabric.

In one embodiment, the fabric further comprises a tackifing layer on at least a portion of the knit fabric over the adhesion layer. The tackifing materials serve to form a tackified finish for facilitating adhesion, or green tack, during the building process of a green tire, hose, or other rubber reinforced products. The tackifing materials serve to promote adhesion between the knit fabric (with the adhesion layer 601) and the rubber during manufacture. The selection of materials for the tackified finish will depend greatly upon the materials selected for use in the reinforced rubber product. In prior art, the entire fabric surface was completely covered in a cement coating of rubber or with a different adhesion promoting or tackifing chemistry. In a tire product, it is desirable to reduce the amount of rubber between the layers as the excess rubber absorbs energy from the running tire and causes early wear and failure. Typical examples of tackifing material include mixtures containing resorcinol formaldehyde latex (RFL), isocyanate based material, epoxy based material, rubber, PVC, and materials based on melamine formaldehyde resin.

In one embodiment, the tackifing layer is a continuous, uniform, non-patterned layer. The tackifing layer may be on one or both sides of the knit fabric.

In another embodiment, the tackifing layer is a patterned coating overlying the adhesion layer on the knit fabric. The patterned tackifing layer may be on one or both sides of the knit fabric over the adhesion layer. The first side and the second side of the knit fabric may contain the same pattern or different patterns. In one embodiment, the tackifing material is placed a first side of the knit fabric (over the adhesion layer) in a patterned coating and on the second side, the tackifing material may be placed as a continuous non-patterned coating.

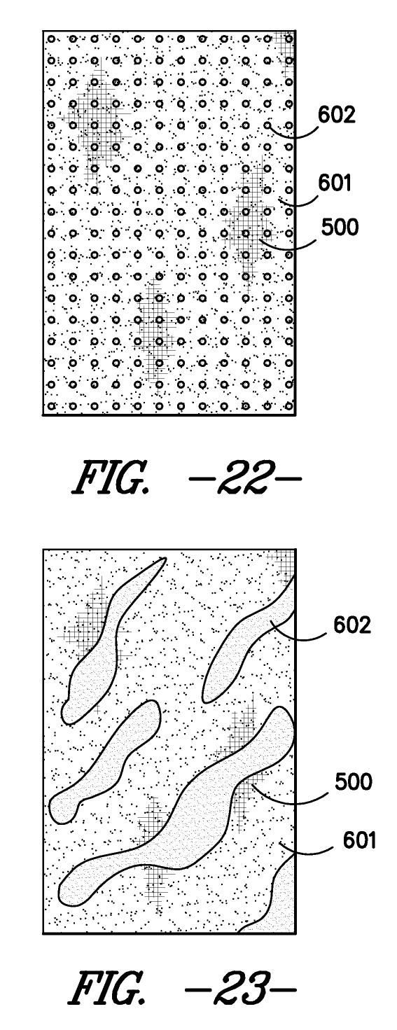

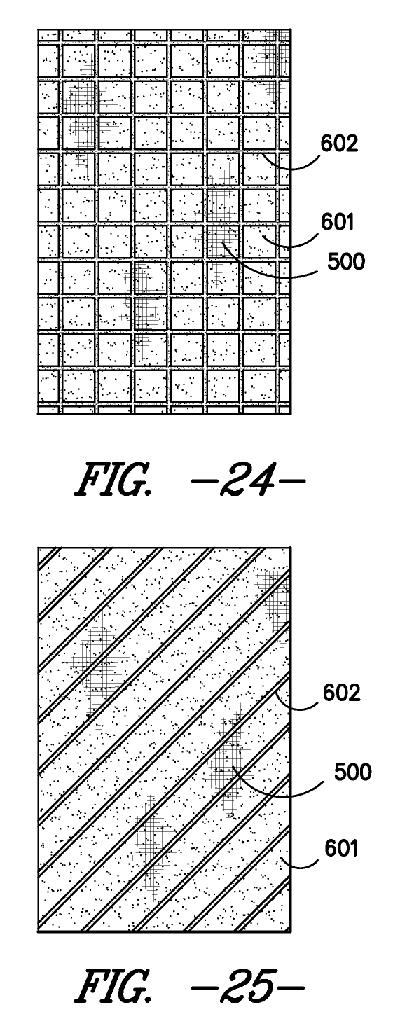

Having the tackifing material in a patterned coating provides for greentack while minimizing the amount of the surface area of the adhesion layer that is covered up and minimizes the amount of rubber and tackifing agents in the tire, hose, or other fabric reinforced rubber products. The patterned coating may be continuous or discontinuous, regular and repeating or random. “Continuous” in this application means that from one edge of the fabric to the other edge there is at least one continuous path that contains the patterned coating and that at least some of the patterned coating areas are connected. Examples of continuous coatings include FIGS. 24 and 25. “Discontinuous” in this application means that the pattern coated areas are discontinuous and not touching one another. In a discontinuous patterned coating, there is no path from one edge of the fabric to the other that contains the patterned coating. Examples of discontinuous coatings include FIGS. 22 and 23. Regular or repeating patterns mean that the pattern has a repeating structure to it. FIGS. 22, 24, and 25 illustrate repeating or regular patterns. FIG. 23 illustrates a random pattern where there is no repeat to the patterned coating. In a random pattern, it is preferred that the random pattern is also discontinuous, not continuous. While the patterned coating is shown as applied to the fabric, a patterned coating of tackifing material may also be applied to the yarns before fabric formation.

FIG. 22 illustrates the embodiment where the patterned coating 602 is in a dot pattern. This pattern is discontinuous and repeating. The dots may be equally spaced on the knit fabric 500 over the adhesion layer 601, or may have differing densities or frequencies of dots, sizing of dots, or size and/or shape of dots across the surface of the fabric. FIG. 23 illustrates the embodiment where the patterned coating 602 is in random, discontinuous spot pattern. FIG. 24 illustrates the embodiment where the patterned coating 602 is in a grid. This pattern is regular and continuous. FIG. 25 illustrates the embodiment where the patterned coating 602 is in a series of parallel lines. This pattern is also regular and continuous. The patterned coating 602 may take any other patterned form including but not limited to indicia, geometric shapes or patterns, and text.

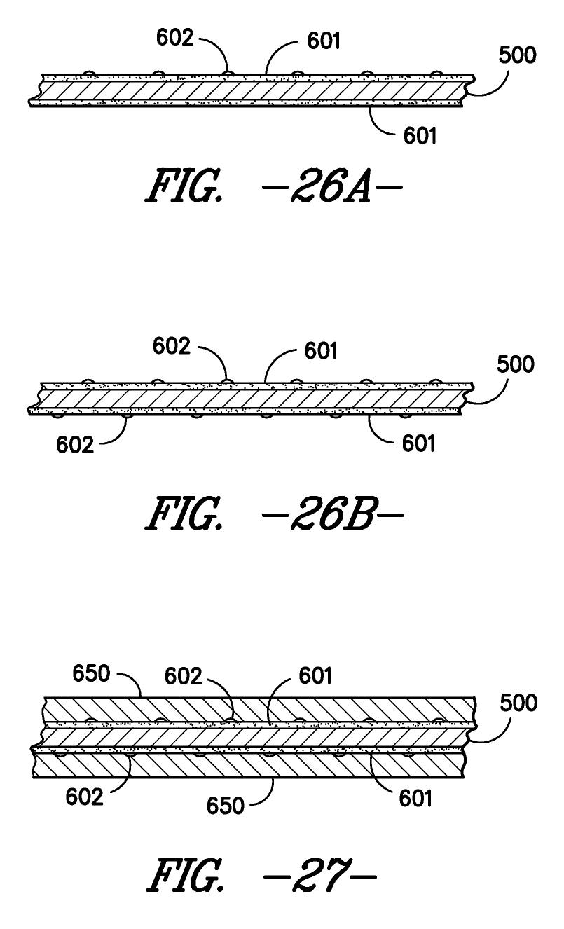

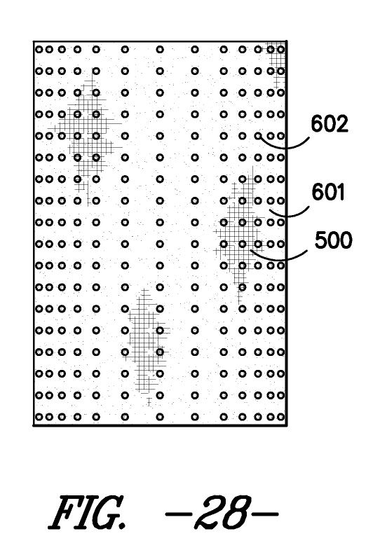

FIGS. 26A and 26B illustrate side views of the coated knit fabric illustrating the patterned coating 602 on one side of the knit fabric 500 (26A) and both sides of the knit fabric 500 (26B) overlying the adhesion layer 601. The patterned coatings 602 may be the same or different patterns and coverage on both sides of knit fabric 500 (over the adhesion layer 601). For example, one side of the knit fabric 500 may have a regular repeating grid pattern covering 10% of the surface area and the other side of the knit fabric 500 may have a discontinuous repeating dot pattern covering 25% of the surface. Each surface pattern may be chosen to optimize the tire production process and article. FIG. 27 illustrates the coated knit fabric embedded into rubber 650. Preferably, the rubber 650 migrates or impregnates partially or fully the knit fabric 500.

In one embodiment, the patterned coating 602 of tackifing material is on the cross-over points in the knit fabric, for example where the warp yarns cross themselves or each other in the knit fabric. In another embodiment, the patterned coating 602 of tackifing material is substantially only on the cross-over points in the fabric and not on the rest of the knit fabric 500 or in the spaces between the stitches of the knit fabric. This may help eliminate or reduce window pane formation from occurring (where the coating forms a film in the open areas of the fabric).

The patterned coating 602 may be formed by any known method of forming a patterned coating including but not limited to inkjet printing, gravure printing, patterned printing, thermal transfer, spray coating, and silk printing. The thickness and/or physical composition of the patterned coating 602 may vary over the length and/or width of the coated knit fabric. For example, it may be preferred in some embodiments to have a thicker coating or more densely packed pattern in some areas of the fabric. This can be seen, for example, in FIG. 28 where the dot pattern of the patterned coating layer varies over the width of the knit fabric to have a higher amount of patterned coating on the edges of the fabric.

In one embodiment, the patterned coating 602 covers between about 5 and 95% of the surface area of the knit fabric 500. In other embodiments, the patterned coating may cover between about 5 and 70%, 10 and 60%, 45 and 75%, greater than 15%, greater than 20% and greater than 30% of the surface area of the knit fabric 500. In another embodiment, the patterned coating 602 has a weight of between about 5 and 60% wt of the knit fabric 500. In other embodiments, the patterned coating has a weight of between about 5 and 50%, 10 and 50%, 10 and 45%, 15 and 35%, greater than 15%, greater than 20% and greater than 30% of the weight of the knit fabric 500.

The formation of the knit fabric begins with the acquisition of the basic yarns for the fabric. Subsequently, the yarns may be twisted to provide additional mechanical resilience. After the twisting, the knit fabric (preferably an atlas knit fabric) may be formed in any suitable manner. Preferably, the knit fabric is knitted into a tubular structure. In one embodiment, rachel knitting is used to form the knit fabric. After the fabric formation, the fabric is finished with an adhesion layer before or after slitting. The adhesion layer may also be applied to the yarns before forming into a fabric. Preferably, the adhesion layer is applied after the tubular fabric is formed but before the fabric is slit into the flat knit fabric. The adhesion layer helps provide stability to the knit fabric and facilitates easier slitting and handling of the fabric. Next, an optional tackifing layer is applied to the flat knit fabric. This may in a patterned or un-patterned manner. The coated fabric is then slit into the desired specific widths for different sidewall fabric applications. In addition to the adhesion layer and/or the tackifing layer, the knit fabric may instead be calendared with rubber to facilitate incorporation into the tire.

The tire formation typically consists of two stages: in the first stage the carcass, the bead components and the sidewalls are put into places. During this stage, all the bead and sidewall reinforcements (chipper, flipper and chafer) are also added to the carcass. At this point the tire is expanded and assumes the typical tire shape. During this passage the knit fabric elongates and takes its final positioning. In the second stage, after expansion, the brakers and the tread compounds are also place. After this the green tire is completed and ready to be molded.

### EXAMPLE 1

A net opening structure fabric with Atlas Tricot stitch 3 rows pattern was produced on a Rachel machine in the pattern shown in FIG. 4A (FIG. 4B shows the chain notation). The machine used (E18 gauge machine) was configured with (18 needles/inch) to produce 7.5 courses/cm. The yarn used for the first warp yarn set and the second warp yarn set were PA66 (nylon 6,6) 235 dtex. The Atlas Tricot stitch 3 rows pattern used had two guide bars half threading (threading of front guide bar is: 1 in; 1 out and threading of guide bar 2 is: 1 out; 1 in). The two bars worked with underlapping of one neighboring needle in opposite direction. The lapping pattern was: bar 1=1.0/1.2/2.3/2.1//, B2=2.3/2.1/1.0/1.2// (See FIG. 4B). The fabric produced may be seen in FIGS. 2 and 3.

### EXAMPLE 2

The fabric of Example 2 was a net opening structure fabric with Atlas Tricot stitch 3 rows pattern produced on a Rachel with weft insertion system machine with the same pattern as Example 1. The warp yarns were PA66 (nylon 6,6) 940 dtex and the fabric also contained a plurality of weft-inserted yarns of rayon 1220 dtex.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A tire comprising:
a pair of beads;
at least one carcass ply extending from one bead to the other bead forming a pair of sidewall areas of the tire and a tread area of the tire; and,
at least one layer of a knit fabric in the sidewall area of the tire, wherein the knit fabric has a warp and weft direction and comprises a first set of warp yarns and a second set of warp yarns, wherein the first set of warp yarns has a repeating pattern comprising:
a first turning stitch,
a stitch shift traversing diagonally at least one wale per at least one course in a first direction,
at least one set of [a stitch and a stitch shift traversing diagonally at least one wale per at least one course] in the first direction,
a second turning stitch,
a stitch shift traversing diagonally at least one wale per at least one course in a second direction opposite to the first direction, and
at least one set of [a stitch and a stitch shift traversing diagonally
at least one wale per at least one course] in the second direction, wherein the second set of warp yarns has a repeating pattern comprising:
a first turning stitch,
a stitch shift traversing diagonally at least one wale per at least one course in the second direction,
at least one set of [a stitch and a stitch shift traversing diagonally at least one wale per at least one course] in the second direction,
a second turning stitch,
a stitch shift traversing diagonally at least one wale per at least one course in the first direction, and
at least one set of [a stitch and a stitch shift traversing diagonally at least one wale per at least one course] in the first direction,
wherein the stitch shifts of the repeating pattern of the first set of warp yarns is a mirror image to the stitch shifts of the repeating pattern of the second set of warp yarns.

2. The tire of claim 1, wherein the knit fabric is an atlas fabric.

3. The tire of claim 2, wherein the atlas fabric is a reverse atlas type fabric.

4. The tire of claim 1, wherein the knit fabric further comprises laid-in weft insertion yarns in the weft direction of the fabric.

5. The tire of claim 1, wherein the knit fabric further comprises a third set of warp yarns in a chain stitch configuration.

6. The tire of claim 1, wherein the knit fabric further comprises a third set of warp yarns, wherein the third set of warp yarns are laid-in warp insertion yarns in the warp direction of the fabric.

7. The tire of claim 1, wherein the knit fabric is a tire fabric selected from the group consisting of a chipper, a flipper, and a chafer.

8. The tire of claim 1, wherein the knit fabric has a first side and a second side and wherein the knit fabric comprises an adhesive layer on at least one of the first and second side of the fabric.

9. The tire of claim 8, wherein the knit fabric further comprises a tackifing layer overlaying a portion of the adhesive layer coating.

10. The tire of claim 9, wherein the coating of the tackifing layer is in a pattern.

11. The tire of claim 1, wherein the first turning stitches of the first set of warp yarns and the second turning stitches of the second set of warp yarns are in the same courses.

12. The tire of claim 1, wherein the first set of warp yarns has a repeating pattern comprising:
a first closed loop turning stitch,
a stitch shift traversing diagonally one wale and one course in the first direction,
an open loop stitch,
a stitch shift traversing diagonally one wale per one course in the first direction,
a second closed loop turning stitch,
a stitch shift traversing diagonally one wale per one course in the second direction,
an open loop stitch, and
a stitch shift traversing diagonally one wale per one course in the second direction,
and wherein the second set of warp yarns has a repeating pattern comprising:
a first closed loop turning stitch,
a stitch shift traversing diagonally one wale and one course in the second direction,
an open loop stitch,
a stitch shift traversing diagonally one wale per one course in the second direction,
a second closed loop turning stitch,
a stitch shift traversing diagonally one wale per one course in the first direction,
an open loop stitch, and
a stitch shift traversing diagonally one wale per one course in the first direction.

13. A method of making a tire comprising:
knitting an tubular-shaped knit fabric having a first side and a second side;
coating the tubular knit fabric with an adhesive layer on at least the first or second side;
slitting the tubular knit fabric forming a flat knit fabric;
optionally applying a tackifing layer to the flat knit fabric overlaying at least a portion of the adhesive layer;
applying the knit fabric to a sidewall area of a green tire; and,
expanding and curing the green tire.

14. The method of claim 13, wherein the tackifing layer is patterned.

15. The method of claim 13, wherein the knit fabric has a warp and weft direction and comprises a first set of warp yarns and a second set of warp yarns, wherein the first set of warp yarns has a repeating pattern comprising:
a first turning stitch,
a stitch shift traversing diagonally at least one wale per at least one course in a first direction,
at least one set of [a stitch and a stitch shift traversing diagonally at least one wale per at least one course] in the first direction,
a second turning stitch,
a stitch shift traversing diagonally at least one wale per at least one course in a second direction opposite to the first direction, and
at least one set of [a stitch and a stitch shift traversing diagonally at least one wale per at least one course] in the second direction,
wherein the second set of warp yarns has a repeating pattern comprising:
a first turning stitch,
a stitch shift traversing diagonally at least one wale per at least one course in the second direction,
at least one set of [a stitch and a stitch shift traversing diagonally at least one wale per at least one course] in the second direction,
a second turning stitch,
a stitch shift traversing diagonally at least one wale per at least one course in the first direction, and
at least one set of [a stitch and a stitch shift traversing diagonally at least one wale per at least one course] in the first direction,
wherein the stitch shifts of the repeating pattern of the first set of warp yarns is a mirror image to the stitch shifts of the repeating pattern of the second set of warp yarns.

16. The method of claim 13, wherein the knit fabric is an atlas fabric.

17. The method of claim 13, wherein the knit fabric further comprises laid-in weft insertion yarns in the weft direction of the fabric.

19. The method of claim 13, wherein the knit fabric further comprises a third set of warp yarns in a chain stitch configuration.

20. The method of claim 13, wherein the knit fabric further comprises a third set of warp yarns, wherein the third set of warp yarns are laid-in warp insertion yarns in the warp direction of the fabric.

21. The method of claim 13, wherein the knit fabric is a tire fabric selected from the group consisting of a chipper, a flipper, and a chafer.
